(19) United States
(12) Patent Application Publication
(10) Pub. No.: US 2026/0341167 A1
(43) Pub. Date: Oct. 29, 2026

(54) METHOD OF MONITORING AND ENHANCING CONTEMPLATIVE PRACTICES USING AN INTERACTIVE ELECTRONIC DEVICE

(71) Applicant: Nathan Bernard, Frisco, TX (US)

(72) Inventor: Nathan Bernard, Frisco, TX (US)

(21) Appl. No.: 19/648,165

(22) Filed: Apr. 15, 2026

Related U.S. Application Data
(60) Provisional application No. 63/793,654, filed on Apr. 24, 2025.

(51) Int. Cl. G09B 5/02; A44C 23/00; A47G 33/00; G06F 3/041; G06F 3/044

(52) U.S. Cl. CPC G09B 5/02; A44C 23/00; G06F 3/04164; G06F 3/044; A47G 33/008

(57) ABSTRACT

The present invention relates to a system for enhancing religious and devotional practices using a handheld devotional device in communication with a computing device via a network. The handheld device includes a plurality of touch-sensitive elements arranged to simulate a traditional rosary, which detect user interaction to monitor and track prayer progression. The computing device, operating through a cloud-based application, receives interaction data and presents dynamic, context-aware spiritual content. The system preserves the tactile nature of prayer, thereby maintaining its meditative quality while eliminating distractions associated with screens. By analyzing user interaction and engagement patterns, the system delivers personalized devotional guidance and insights, allowing users to deepen their understanding and commitment to their faith. The solution also supports consistent practice, spiritual reflection, and long-term growth through adaptive content delivery and progress tracking.

### CROSS-REFERENCE TO RELATED APPLICATIONS

I hereby claim the benefit under 35 U.S.C. Section 119(e) of U.S. Provisional application No. 63/793,654, filed Apr. 24, 2025, which is hereby incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The present invention relates to systems for monitoring and enhancing devotional practices including contemplative, meditative and reflective practices which may relate to religious practices, and specifically, relates to a system that enhances devotional practices by utilizing a handheld devotional device to monitor, track, and dynamically improve user engagement in traditional devotional rituals.

### (2) Description of Related Art Including Information Disclosed Under 37 CFR 1.97 and 1.98

Traditional devotional practices, such as rosary prayer, are typically a deeply meditative and tactile devotional practice that plays a central role in spirituality. As one example, a Catholic rosary involves a structured progression of prayers, typically recited while the user manually moves their fingers over each bead of the rosary. This physical interaction is intended to ground the mind, promote focus, and encourage spiritual reflection. However, the effectiveness of this practice depends heavily on the user's familiarity with the prayers and mysteries of the rosary. For many users, especially those newer to the faith or returning after a long absence, this deep knowledge is often lacking, which makes it more difficult to engage meaningfully with the practice.

Another common issue with traditional rosary prayer is that it requires a consistent, focused commitment over time. Many users struggle to maintain the discipline necessary for daily or frequent recitation. In the absence of external accountability or tracking, it becomes difficult for individuals to know how often they are truly engaging with the rosary, or to assess the quality of their prayer time. This challenge is further compounded by the fact that traditional rosaries do not offer any built-in mechanism for recording progress or providing spiritual insights based on usage patterns.

In an effort to modernize this sacred tradition, a number of mobile applications and audio-guided rosary tools have been introduced. These tools aim to facilitate the rosary prayer by offering guided audio tracks, visual prompts, and digital prayer logs. While helpful in some aspects, these applications present a number of critical limitations. Most notably, they do not track user interaction at the individual bead level. That is, they may record that a user initiated a rosary session or listened to an audio track, but they cannot detect whether the user actively engaged with each prayer or completed the rosary in full.

Additionally, these digital rosary tools typically operate at a fixed pace. The user must keep up with the rhythm of the app, rather than the app adapting to the pace and depth of the user's engagement. This can be frustrating for individuals who may wish to pause for deeper meditation or who pray at varying speeds. The lack of adaptability reduces the prayer experience to a passive activity rather than an interactive, contemplative one.

Furthermore, most existing rosary applications offer only minimally curated content. They tend to repeat the same standard prayers without considering the user's prior knowledge, progress, or areas for growth. As a result, experienced users may find the content repetitive or uninspiring, while beginners may find it too advanced or disconnected from their current understanding of the faith. These solutions also do not take advantage of modern techniques to deliver dynamic, personalized spiritual content in real time.

A major drawback of existing rosary apps is the lack of physical interaction. By requiring users to rely on their smartphones or tablets, these tools separate users from the tactile experience that is central to the traditional rosary. The act of physically moving from bead to bead is not only part of the ritual but also serves to guide prayer and focus the mind. With digital-only interfaces, this essential tactile component is lost, thereby potentially reducing the prayer's effectiveness and spiritual depth.

Some prior art attempts have incorporated electronic rosaries or smart beads, such as the “Click to Pray eRosary”, which is an interactive, mobile app-connected wearable device with a cross-shaped smart component designed to help users learn and pray the Rosary for world peace. Worn as a bracelet, it activates upon making the sign of the cross and syncs with a free companion app. The mobile app provides access to an audio guide, exclusive images, and personalized content to enrich the Rosary prayer experience. These devices offer basic digitization, including usage tracking and guided prayer sessions. However, they typically do not support real-time tracking of individual bead interactions or offer personalized spiritual feedback. Additionally, they rely heavily on continuous interaction with a mobile device, which may interrupt the tactile and meditative nature of traditional prayer.

To address these limitations, there is a need for a system that enhances religious and devotional practices by utilizing a handheld devotional device to monitor, track, and dynamically improve user engagement in traditional prayer rituals. There is also a need for a system that preserves the tactile nature of prayer while eliminating the distractions associated with smartphones and screens, thereby maintaining the meditative quality of the practice. Further, there is also a need for a system that delivers personalized, context-aware spiritual content based on user behavior and progress, and that provides actionable insights to help users to grow in their understanding and commitment to their faith over time.

### BRIEF SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments nor delineate the scope of any or all embodiments.

The present disclosure, in one or more embodiments, relates to a system that enhances religious and devotional practices by utilizing a handheld devotional device in combination with a computing device to monitor, track, and improve user engagement in traditional prayer rituals. The system preserves the tactile nature of prayer while eliminating distractions associated with smartphones and screens, thereby maintaining the meditative quality of the practice. The system also delivers personalized, context-aware spiritual content based on user interaction and progress, and provides actionable insights that support users in deepening their understanding and commitment to their faith over time.

In one embodiment herein, the handheld devotional device comprises a plurality of touch-sensitive elements arranged in a configuration that corresponds to a traditional rosary. Each touch-sensitive element is associated with a bead of the handheld devotional device and configured to detect user interaction and facilitate sequential tracking of prayer progress.

In one embodiment herein, the handheld devotional device includes a microcontroller that is electrically connected to each of the touch-sensitive elements. The microcontroller is configured to detect and identify individual touch events from each touch-sensitive element, thereby enabling accurate recognition of user interactions and corresponding progress within the prayer session.

In one embodiment herein, the handheld devotional device also includes a communication module that is configured to connect the handheld devotional device to the computing device via a network. This connection facilitates the real-time transfer of interaction data from the handheld device to the computing device.

In one embodiment herein, the computing device is configured to receive the transmitted user interaction data from the handheld devotional device. The computing device executes a cloud-based application that processes the received data to display corresponding prayer content, track prayer session progress, and generate user engagement insights.

In one embodiment herein, the cloud-based application dynamically updates the displayed content based on the user's interactions. This may include context-aware reflections, scripture passages, or prayer intentions that correspond to the user's position in the prayer structure, thereby enhancing the spiritual experience and maintaining a high level of user engagement.

In one embodiment herein, the system also tracks and logs engagement data, which includes the frequency, duration, and completeness of prayer sessions. This data is stored and made accessible to the user through the cloud-based application, thereby allowing the user to reflect on devotional habits, assess spiritual consistency, and set goals for continued growth. The system may further generate suggestions tailored to the user's engagement patterns, thereby supporting deeper involvement in devotional practices.

In one embodiment herein, the system provides customization options through the cloud-based application. The user may select preferred prayer content, language, and devotional structure. Additionally, the system offers various pacing modes to accommodate both novice and experienced users, thereby ensuring that the prayer experience is accessible and meaningful for all levels of spiritual practice.

In one embodiment herein, the handheld devotional device is powered by a power source to enable extended use without frequent recharging. The construction of the handheld devotional device is both durable and lightweight, thereby ensuring ease of use, portability, and reliability across various usage environments.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic block diagram of a system for monitoring and enhancing devotional practices, in accordance with embodiments of the disclosure.

FIG. 2 is a schematic front view of a handheld devotional device of the system, in accordance with embodiments of the disclosure.

FIG. 3 is a schematic block diagram of the handheld devotional device, in accordance with embodiments of the disclosure.

FIG. 4 is a schematic block diagram of circuitry of the handheld devotional device, in accordance with embodiments of the disclosure.

FIG. 5A and FIG. 5B contain first and second portions of a schematic flowchart of a method for monitoring and enhancing devotional practices using the system, in accordance with implementations of the disclosure.

FIG. 6 is a schematic flowchart illustrating aspects of the method for executing a prayer sequence in a coupled mode of operation between the handheld devotional device and a computing device, in accordance with implementations of the disclosure.

FIG. 7 is a schematic diagrammatic representation of a progression of operational states of the system, in accordance with implementations of the disclosure.

FIG. 8 is a schematic front view of an interactive electronic device displaying a representation of a prayer card, in accordance with implementations of the disclosure.

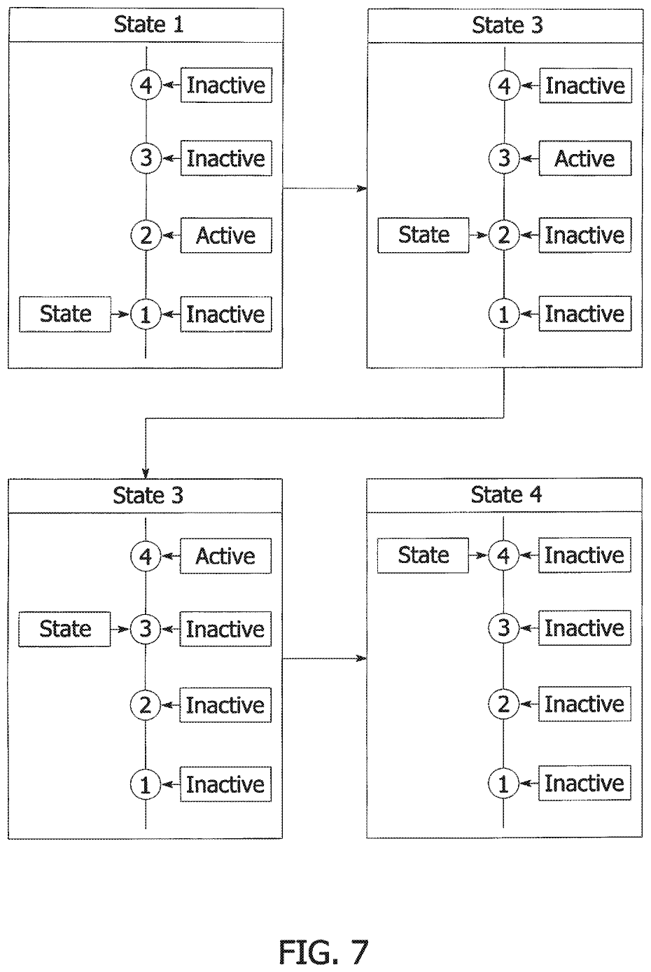

FIG. 9 is a schematic flowchart illustrating aspects of a method for generating devotional or contemplative content, such as a prayer card, by the system for use in a prayer sequence, in accordance with implementations of the disclosure. I

FIG. 10 is a schematic flowchart illustrating aspects of a method for processing content by the system in performing the method depicted in FIG. 9 using input such as user content, in accordance with implementations of the disclosure.

### DETAILED DESCRIPTION OF THE INVENTION

Reference will now be made in detail to the present preferred embodiments and implementations of the invention, examples of which are illustrated in the accompanying drawings. Wherever possible, the same reference numerals are used in the drawings and the description to refer to the same or like parts.

While the disclosure includes description of exemplary embodiments and methods as applied to Christian, and more specific Catholic, items for use in devotional and contemplative practices, it should be recognized that the advantages and benefits of aspects of the disclosure are not necessarily limited to practices of these faiths, and may be extended to practices of other faiths such as, for example, Anglican prayer beads, Islamic Misbaha/Tasbih, Buddhist and Hindu mala beads, Orthodox prayer ropes, and other devices of various faiths and traditions. Further, the advantages and benefits of the aspects of the disclosure are not limited to practices related to religions or traditions, and may also be utilized with educational tools, therapeutic devices, rehabilitation aids, as well as other systems or components which benefit from, for example, devices providing ordered sequence validation using individual touch sensors in a physical arrangement.

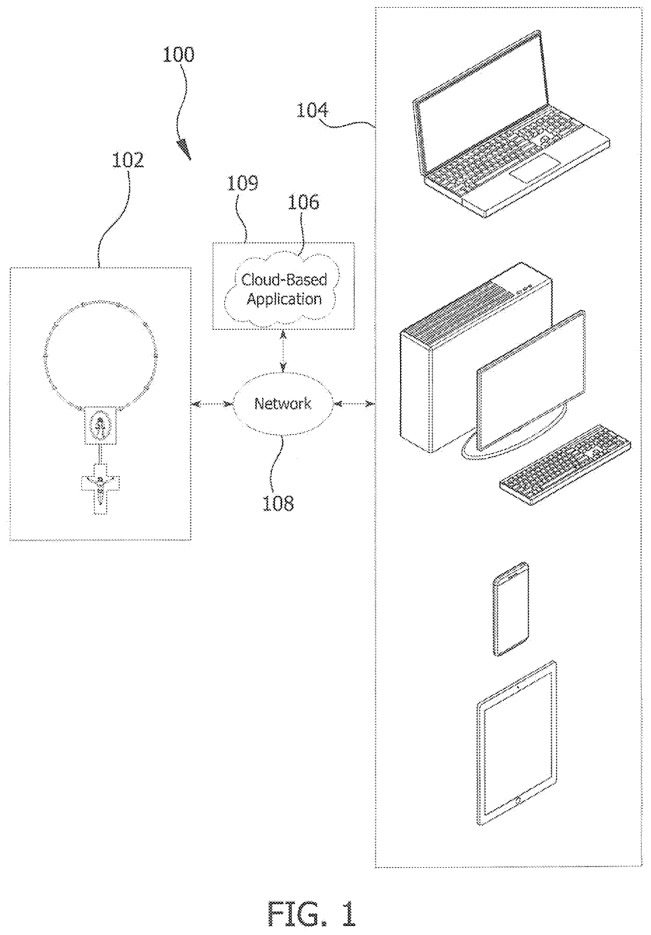

FIG. 1 refers to a block diagram of a system 100 for monitoring and enhancing devotional practices. In one embodiment herein, the system 100 preserves tactile nature of prayer while eliminating distractions associated with smartphones and screens, thereby maintaining the meditative quality of the practice. The system 100 also delivers personalized, context-aware spiritual content based on user interaction and progress, and provides actionable insights that support users in deepening their understanding and commitment to their faith over time. In one embodiment herein, the system 100 comprises an interactive electronic device, such as a handheld devotional device 102, a computing device 104, and a cloud-based application 106 connected via a network 108. Each component is configured to work together to enable tactile interaction, real-time tracking, and enhanced engagement during traditional prayer rituals.

In one embodiment herein, the computing device 104 represents one or more user-accessible electronic devices, which include, but are not limited to, a laptop, a desktop computer, a tablet, and a smartphone. The computing device 104 is configured to communicate with the handheld devotional device 102 over the network 108 to receive interaction data. The computing device 104 further interfaces with the cloud-based application 106, which processes the received data to display appropriate prayer content and track user engagement.

In one embodiment herein, the cloud-based application 106 operates remotely from the computing device 104. The cloud-based application 106 receives and processes data from the computing device 104, which includes user touch interactions from the handheld devotional device 102. The cloud-based application 106 manages content delivery, tracks user behavior over time, and may store data logs that are accessible by the user through the computing device 104. In one embodiment herein, the network 108 represents any communication infrastructure capable of supporting data exchange between the handheld devotional device 102 and the computing device 104. The network 108 may include wireless or wired connections, such as Wi-Fi, Bluetooth, or mobile data communication channels.

The cloud-based application 106 may be resident on a computing system 109 and may function as backend infrastructure for the system 100 that communicates with an application running on a user's computing device 104 as well as a user's handheld devotional device 102. In embodiments, the computing system 109 may manage, store, and provide information for individual users of the application 106 while also supporting controlled interaction with content generated by other users. The computing system 109 may have a variety of additional functions including user account management which may comprise storing user profiles, user authentication information, and historical interaction data of each user. The user account management function may also include maintaining a content profile for each user including a listing of prayers, meditations, and card interactions utilized by the user in the past.

Another function of the computing system 109 may relate to content storage and delivery, including storing system-generated and user-generated content, such as prayer cards, navigation cards, and content card sequences. The content storage and delivery function may also include providing content to the computing device 104 of the user as needed for display and interaction within the application 106, and functionality may include tracking and updating prayer card metadata and engagement statistics (e.g., number of prayers, unique users, time spent, etc. for the prayer card). Yet another function of the computing system 109 may relate to user interaction and engagement and may include enabling users to access and engage with content generated by other users in a controlled manner to support shared contemplative or meditative experiences. The user interaction engagement functionality may also include facilitating the collection of interaction metrics for use in generating system analytics, sequence personalization, and automated content selection. Still another function of the computing system 109 may relate to support for automated sequence generation and may include supplying the application 106 with content, semantic data, and user-specific profiles needed to build personalized prayer sequences. The supportive functionality may also include maintaining the data and computational infrastructure necessary to implement algorithms that select content based on semantic similarity, diversity, and ontological relationships.

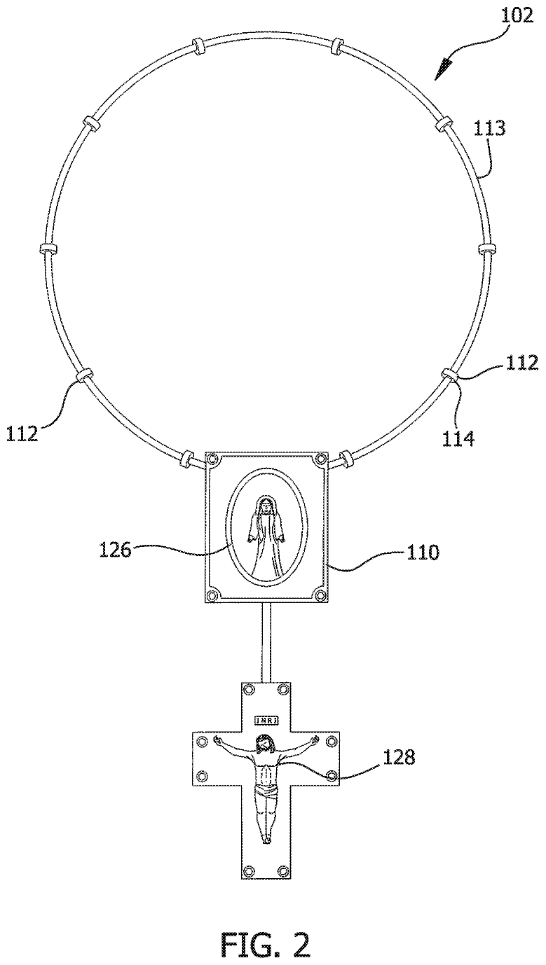

FIG. 2 refers to a front view of the handheld devotional device 102 of the system 100. In one embodiment herein, the handheld devotional device 102 is configured in the form of a traditional rosary. The handheld devotional device 102 comprises a housing 110 that forms a portion of the structure of the handheld devotional device 102. In some rosary embodiments of the device 102, the housing 110 may be associated with the crucifix component of the rosary, while in other rosary embodiments the housing 110 may be associated with the centerpiece component of the rosary. The devotional device 102 may include a connecting framework 113 that links the individual beads 112 together, and may provide a degree of support to the beads. The connecting framework 113 may be elongated and may support the beads 112 in a series arrangement, such as supporting the beads at spaced locations along the framework. Illustratively, at least a portion of the connecting framework 113 may form a loop. A distributed configuration of the housing 110 allows the handheld devotional device 102 to maintain a lightweight and ergonomic profile, thereby preserving the traditional tactile form factor of the rosary while integrating modern functional components. The connecting framework 113 may support the beads 112 in an arrangement or pattern corresponding to that of the traditional rosary. The connecting framework 113 may be flexible in character to facilitate contact and manipulation of the beads 112 in the hands of the user. These beads 112 serve as individual points of contact for the user to engage with during prayer rituals. The arrangement supports sequential interaction, thereby enabling the user to progress through the devotional structure in a natural and familiar manner.

In one embodiment herein, the handheld devotional device 102 also comprises a plurality of touch-sensitive sensors or elements 114 capable of sensing when contact is made with the element, such as by a finger or fingers of the user. At least some of the touch sensitive elements 114 are located on or embedded within the individual beads 112, but the elements may be located on or incorporated with other components of the devotional device 102 such as the centerpiece component and the crucifix component, either of which may include the housing 110. Each touch-sensitive element 114 can be, but is not limited to, a conductive element forming a capacitive touch sensor. Other technologies useful for detecting touch or pressure by the touch sensitive element 114 may include resistive, piezoelectric, or optical technologies. The touch-sensitive elements 114 are configured to generate capacitance values which may vary as a result of user interaction with the element in the form of contacts by the user through, for example, touches or presses on the element by the fingers of the user. These interactions facilitate the tracking of the user's prayer progress. The integration of the touch-sensitive elements 114 within the beads 112 enables the handheld devotional device 102 to maintain the tactile engagement essential to traditional rosary use while supporting enhanced monitoring and feedback capabilities. The design configuration enables the handheld devotional device 102 to provide a seamless blend of tradition and technology. The physical structure preserves the spiritual and meditative aspects of the rosary while enabling interaction data to be captured and utilized for reflection, content delivery, and personalized spiritual growth.

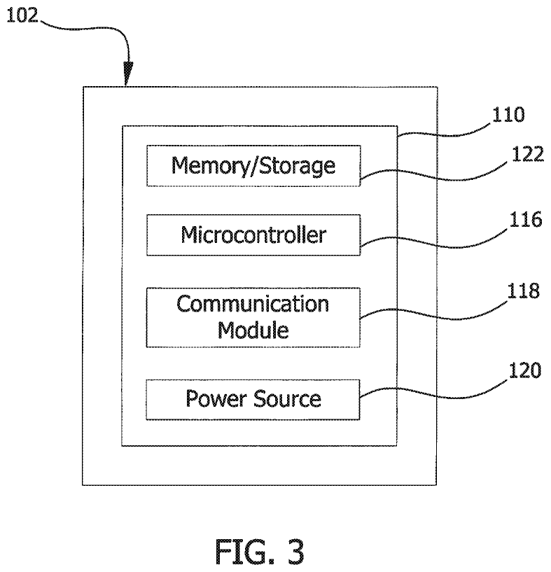

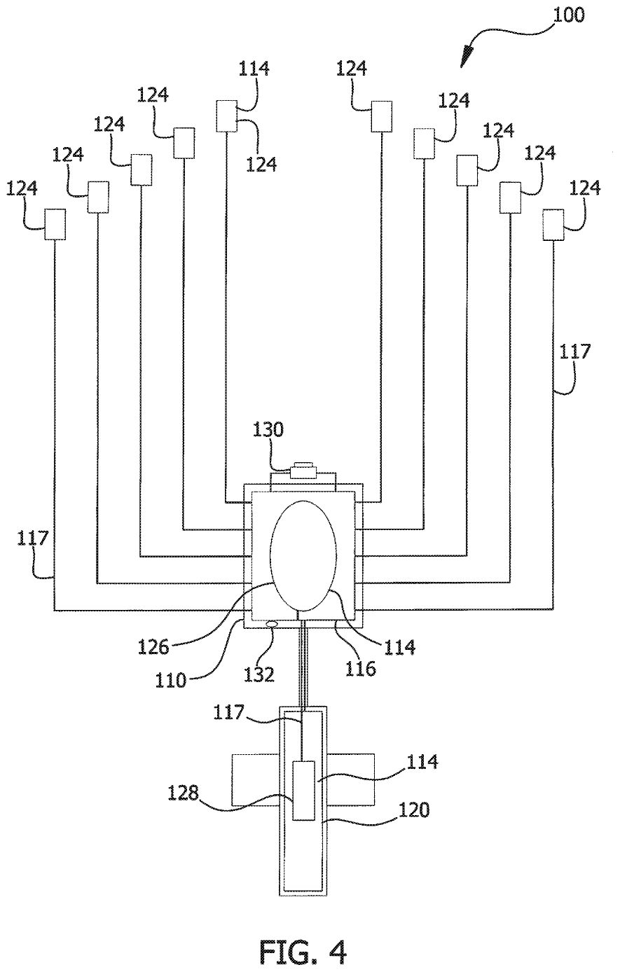

FIG. 3 refers to a block diagram of the handheld devotional device 102. In one embodiment herein, the housing 110 of the handheld devotional device 102 encases and protects multiple electronic components required for its operation. The housing 110 includes a microcontroller 116 that is operatively connected to the touch-sensitive elements 114 (shown in FIG. 2) embedded in the beads 112 (shown in FIG. 2) of the handheld devotional device 102. The microcontroller 116 is configured to detect, identify, and process individual touch interactions made by the user. These interactions correspond to specific aspects of a devotional practice, such as prayer progressions, and form the basis for user engagement tracking. In illustrative embodiments, the microcontroller 116 may continuously or substantially continuously receive raw capacitance values from each of the touch sensitive elements 114, and the raw values may be converted to binary values (e.g., 0/1, or off/on) based on a deviation of the value from a baseline capacitance value. Each of the touch sensitive elements 114 are individually connected to individual inputs on the microcontroller 116 by distinct and separate conductors, such as shown in FIG. 4, to provide the microcontroller with the ability to detect touch contact with each of the beads in a manner that discriminates between the individual touch sensitive elements, and thus the individual beads as well as the centerpiece component in the crucifix component. For example, the conductors may comprise electrically conductive wires or, as a further example, the conductors may comprise light conducting fibers. In some embodiments, the conductors connecting the touch sensitive elements 114 to the microcontroller 116 may form a portion of the connecting framework 113. Firmware of the device 102 may retain the binary values of each of the touch sensitive elements 114 over time. The microcontroller 116 may perform additional functions in addition to determining the current state, including tracking the history of the states, measuring the duration of activation of the touch sensitive elements and intervals between activations to verify valid sequence progression; compiling cumulative data for each sequence, such as total time spent, number of sensors activated, and completion status; and facilitating recovery of a prayer sequence session after power loss or interruption to device operation so that the prayer sequence can be resumed.

In one embodiment herein, the handheld devotional device 102 may also comprise a communication module 118, which is configured to establish a connection between the handheld devotional device 102 and the computing device 104 (shown in FIG. 1) via the network 108 (shown in FIG. 1). The communication module 118 facilitates the transmission of interaction data to the computing device 104, thereby enabling real-time content synchronization, monitoring, and devotional feedback. In illustrative embodiments, the communication module 118 is associated with the housing 110, and the module may be located in the interior of the housing. Embodiments of the devotional device 102 may include a power source 120 provided to supply electrical power to the touch-sensitive elements 114, the microcontroller 116, and the communication module 118 of the handheld devotional device 102. The power source 120 may be located in the housing 110 or may be located in another enclosure associated with the device 102. The power source 120 can be, but is not limited to being, a rechargeable battery that is designed to support extended use, thereby allowing the users to participate in devotional practices over long periods without frequent recharging or replacement.

Embodiments of the handheld devotional device 102 may include storage or memory 122 of one or more types suitable to enable data handling during the operation of the device as well as retention of data, such as when the device 102 is powered off. More specifically, the memory 122 may contain machine-readable instructions for the operation of the device 102 by the microcontroller 116. The memory 122 may be incorporated with the circuitry of the microcontroller 116, or the memory may be a component separate of the microcontroller which is in communication with the microcontroller. The memory 122 may be located in the housing 110. In embodiments, the devotional device 102 may be configured to retain the full prayer session information for multiple devotional sessions, even when the device 102 is not in active communication with a computing device 104 which may enable the option of non-visual prayer experiences, such as following a traditional rosary sequence. Other data that may be retained in the memory 122 includes the current state of an ongoing or in progress prayer sequence, a listing of completed prayer sequences that have not yet been transmitted to the computing device 104, and prayer session-specific metadata, such as timestamps, sequence type, and sensor activation logs. When the devotional device 102 establishes communication with the computing device 104, data regarding completed prayer sequences and other associated data may be uploaded to the device 104 and, once successfully transmitted and acknowledged, the transmitted data regarding the sequences may be removed from the memory 122 in order to conserve storage space on the device 102.

Illustratively, key operational instructions for operation of the handheld devotional device 102 may be permanently coded into non-volatile memory of the microcontroller and may include firmware responsible for interpreting inputs from sensors, state machine operation, sequence tracking, and signal generation. Memory 122, such as memory of the Random Access Memory (RAM) type, may be utilized by the microcontroller 116 during operation of the device 102 to temporarily store the values of variables required by the firmware. Examples of these variables include the current states of the touch sensitive elements (e.g., binary on/off values), indicators of active state identifiers within the state machine, timing counters for determining sequence initiation and progression, and temporary session data during a prayer sequence such as the current prayer sequence. The RAM memory 122 may not store the permanent operational code for the device 102 but may facilitate real-time execution of the firmware instructions. In embodiments of the devotional device 102, the firmware resident in memory 122 may be updated. For example, the code for the microcontroller 116 may be updated over time using over-the-air (OTA) techniques via communication with the computing device. Firmware updates may permit the handheld devotional device 102 to receive new or revised operational instructions, algorithms, or functionality enhancements without requiring physical modification of the device. Illustratively, RAM memory 122 may be utilized temporarily to hold firmware code during the firmware updating process until the code can be written to non-volatile memory.

Implementations of the system 100 may collect or track data on various metrics related to the prayer activity of a user of the system, such as the handheld devotional device, content creation, and the device user's engagement with content. These metrics can inform various future operational characteristics of the device 102, such as sequence personalization, content recommendations, and goal tracking. In implementations, the system 100 may track data related to prayer activity metrics of one or more users of the system, including, for example:
1. The number of prayers and/or prayer sequences completed by the user over a time period such as a week, a month, or a year.
2. The mixture of types of prayers and/or prayer sequences completed by the user including the distribution of different types of prayers or sequences performed (e.g., Rosary, Divine Mercy Chaplet, user-defined sequences).
3. The time elapsed since completion of the most recent prayer session.
4. The average prayer sequence completion rate calculated by dividing the number of sequences completed by the number of sequences attempted.
5. The user's progress toward prayer goals defined by the user and/or prayer goals assigned by the system (e.g., number of prayers per week).
6. The user's total time spent in prayer over a selectable time period.
7. The average duration of the user's prayer sequences.
8. The consistency or regularity of the user's prayer sessions (e.g., consecutive days with completed prayers).

In one embodiment herein, the arrangement of the electronic components within the housing 110 ensures a compact and portable design, while maintaining the functional integrity of the handheld devotional device 102. This internal configuration supports seamless interaction with the physical structure of the beads 112 and allows the handheld devotional device 102 to operate independently or in conjunction with the external devices to enhance the user's religious and devotional experience.

FIG. 4 shows a block diagram representative of circuitry components of an illustrative handheld devotional device 102 with a configuration suitable for use as a rosary. The embodiment of the handheld devotional device 102 includes a plurality of touch sensitive elements 114, including touch sensitive elements 124 associated with each of the beads 112 of the device 102 as well as a touch sensitive element 126 associated with the centerpiece component of the device 102 and a touch sensitive element 128 associated with the crucifix component of the device 102. Each of the touch sensitive elements 114 is individually and separately electrically connected to the microcontroller 116 to enable the microcontroller to discriminate between touches or contacts by the user with each of the components of the rosary, including the beads, the centerpiece, and the crucifix. Illustratively, for the touch sensitive element of each component, such as the element 114 of a bead 112, as well as the touch sensitive element 126 for the centerpiece and the touch sensitive element 128 for the crucifix, a discrete conductor extends from the touch sensitive element of the component to a discrete input of the microcontroller 116 of the device.

In the illustrative embodiment, the power source 120 is located on the crucifix component of the rosary while the microcontroller 116 is located on the centerpiece component. Additionally, a power switch 130 may be included in the circuitry for selectively initiating and terminating active operation of the device 102, and illustratively the power switch is located on the centerpiece component. A light emitting device or indicator 132 may be located on a component of the device 102 to provide visual indications to the user of various conditions, such as the detection of a touch interaction with an element 114, a power on condition of the device, completion of a prayer sequence, etc.

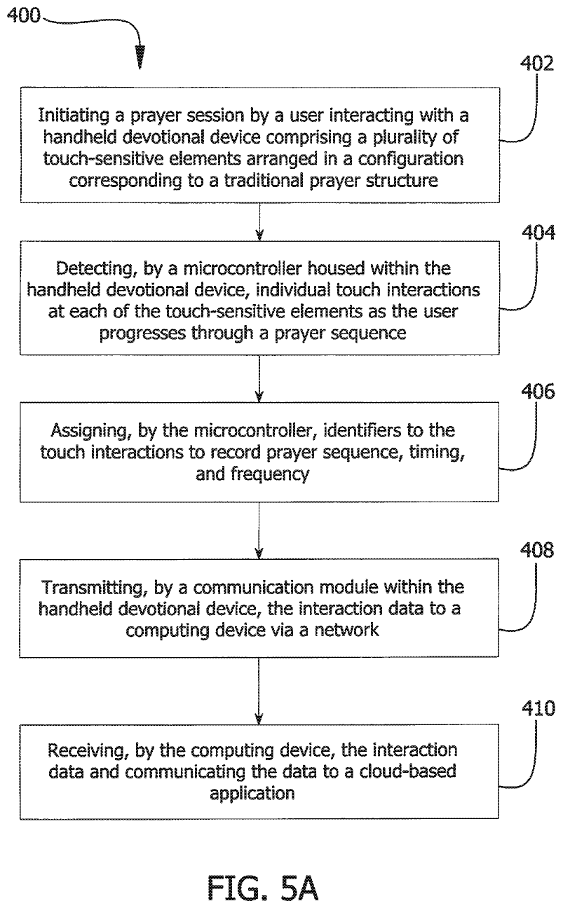

FIG. 5A and FIG. 5B disclose a flowchart 400 with one illustrative implementation of the method for monitoring and enhancing devotional practices using the system 100. The illustrative implementation of the method begins with initiating a prayer session by the user interacting with the handheld devotional device 102 at step 402. The handheld devotional device 102 comprises the touch-sensitive elements 114, such as capacitive touch sensors, arranged in a configuration that corresponds to a traditional devotional practice such as a prayer structure, for example, a Catholic rosary. This layout enables the user to maintain the physical, meditative rhythm of prayer by touching each bead 112 sequentially, as they would with the conventional rosary, thereby initiating the process in a familiar, tactile manner.

As the user progresses through the prayer sequence, the microcontroller 116 embedded within the handheld devotional device 102 detects individual touch interactions on the touch-sensitive elements 114 at step 404. Each touch-sensitive element 114 corresponds to a specific prayer or devotional step, and the microcontroller 116 registers the occurrence, timing, and location of each touch event. This allows the system 100 to recognize the user's progress throughout the prayer session in a precise and uninterrupted manner. Upon detecting the touch inputs, the microcontroller 116 assigns identifiers to each touch interaction at step 406. These identifiers are mapped to specific beads 112 and prayer steps, thereby enabling the recording of the prayer sequence, the timing between beads, and the frequency of interactions. This structured data is essential for evaluating the user's engagement with the devotional practice and forms the basis for generating reflective insights later in the method.

Later, at step 408, the interaction data recorded by the microcontroller 116 is transmitted to the computing device 104 via the communication module 118 embedded in the handheld devotional device 102. The communication module 118 may support various suitable communication technologies, including communication technologies utilizing physical connections, such as electrical wire and optical fiber, and wireless communication technologies utilizing, for example, radio frequency and infrared transmitted signals and communication protocols such as cellular data, Wi-Fi or Bluetooth (including Bluetooth Low Energy) to establish a network connection. The seamless data transmission ensures that the user's prayer activity is captured in real time and made available for further processing without requiring the user to interrupt their session. Later, at step 410, the computing device 104 receives the transmitted interaction data and communicates it to the cloud-based application 106. This step ensures that the data collected from the handheld devotional device 102 is centralized and made accessible for cloud processing, long-term storage, and synchronization across multiple user devices if needed.

Later, at step 412, the cloud-based application 106 analyzes the interaction data to determine the user's prayer activity and context. This analysis may involve evaluating patterns such as which prayers are most frequently recited, how consistently the user completes prayer sessions, and how long the user spends on each part of the prayer cycle. This contextual understanding supports the generation of tailored devotional experiences. Based on the analysis, the cloud-based application 106 dynamically presents personalized prayer content on the user's computing device 104 at step 414. This content may include relevant scripture passages, spiritual reflections, or curated intentions that correspond to the user's progress in the prayer cycle. The personalization ensures that the devotional experience evolves with the user's spiritual needs, habits, and learning goals.

In addition to content presentation, the system 100 logs various engagement metrics associated with the user's devotional sessions at step 416. These metrics may include session duration, the number of completed prayers, pauses or interruptions, and interaction frequency with specific beads. The metrics provide a quantitative overview of the user's devotional habits over time. At step 418, the cloud-based application 106 uses the logged engagement metrics to generate personalized insights for the user. These insights may include assessments of consistency, prayer duration trends, missed devotional opportunities, and recommendations for new prayers or reflections that align with the user's spiritual journey. This encourages users to develop deeper and more structured devotional habits.

Finally, at step 420, the personalized insights are presented on the computing device 104 through the cloud-based application 106. The cloud-based application 106 further allows the user to configure their prayer preferences, such as selecting preferred languages, adjusting the structure or order of prayers, and choosing thematic focuses such as gratitude, forgiveness, or intercession. This configurable setup ensures the devotional experience remains tailored, accessible, and supportive of the user's spiritual growth goals.

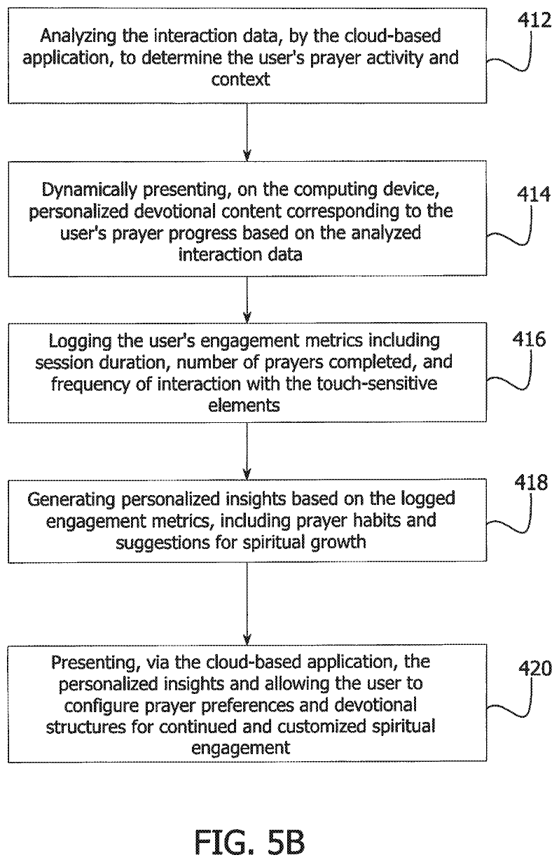

Another illustrative implementation of the method of the disclosure is shown in flowchart 600 of FIG. 6, and the implementation is particularly directed to a method which utilizes both the handheld devotional device 102 and the computing device 104 of the system in a coupled or connected mode of operation for a devotional session. At step 602, as a part of a sequence initiation, an application on the computing device application transmits a start instruction to the handheld devotional device to initiate a prayer sequence. The start instruction may also include information such as details of the prayer sequence and at what point in the prayer sequence the session should begin, if the session is a continuation of a previous session. The devotional device 102 may enter an initial state corresponding to a first step or state of a predefined sequence of states. Each state may be associated with a defined subset of the touch sensitive elements 114 designated as active. At step 604, the microcontroller 116 of the device may monitor inputs to the microcontroller only from the active subset of the touch sensitive elements 114 and may ignore inputs from non-active elements 114. At step 606, upon detection of a valid input from any of the active touch sensitive elements, the microcontroller 116 may trigger a transition to the next state in the predefined sequence of states. Conversely, the microcontroller 116 may not transition to the next state if the microcontroller determines that an input received from one of the touch sensitive elements is out of sequence and therefore invalid. For example, if a user touches a wrong bead, such as a bead that is not the next bead in the sequence, the microcontroller may not register anything and as a result the incorrect bead touch does not impact usage or cause a transition to the next state. Also, microcontroller 116 may not trigger a state transition if the user's touch of the adjacent bead before a time threshold has passed. Because the device 102 is often held by the user with both of the user's hands, one hand will typically be in the active area of the device (e.g., rosary) while the other hand touches beads on another portion of the device, and in active area such as the opposite side of the rosary's loop. As a result, the ability of the microprocessor 116 to discriminate between a touch of a bead in the active area and a bead or beads in the inactive area of the device is highly advantageous and the state machine is protected from registering disordered sequences of bead touches. If the controller detects that the user's touch has skipped one of the beads in the sequence, a debouncing period may cause a delay but may eventually produce a transition if the microcontroller detects that the skipped bead, or the next bead in the sequence, is touched after the out of sequence bead. This operation may be affected by whether the system is operating in the coupled or uncoupled mode. In the coupled mode, if a bead in the sequence is skipped, then the computing device 104 may not transition during the debouncing period and the user may notice the lack of a transition and likely will react by going back a bead in the arrangement of beads and touch skipped bead. Therefore, the state algorithm may protect against a user progressing by going out of sequence, as progress is only registered if the user touches the beads in the sequence active for that prayer session.

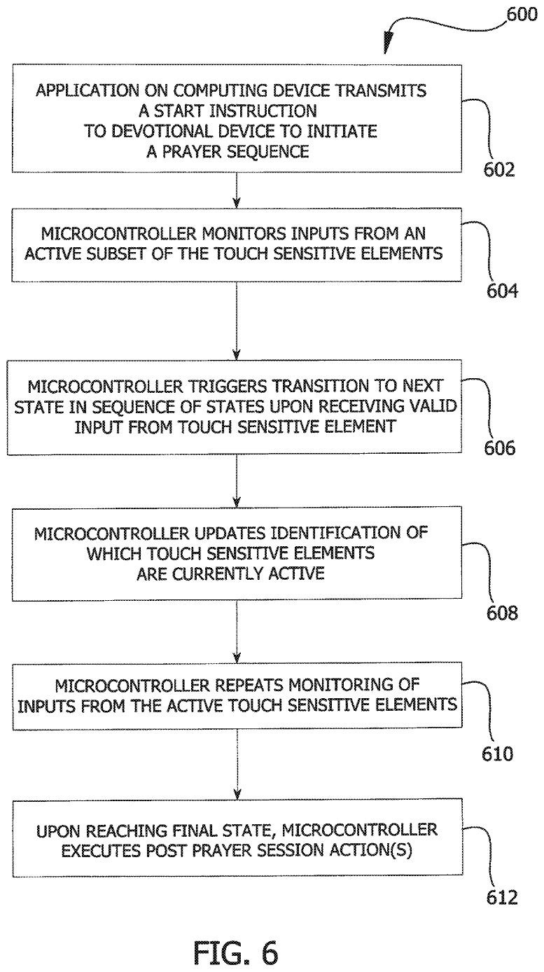

Within a devotional session, a sequence of the states may be registered or recorded as metadata. Upon the occurrence of a transition, the microcontroller 116 of the device may update an identification of which elements 114 are currently active according to the mapping for the new state at step 608. See, for example, FIG. 7 which depicts an illustrative progression of the states relative to the active and inactive conditions of the touch sensitive elements. Returning to FIG. 6, at step 610, the monitoring of the microcontroller inputs associated with the active elements 114 and the transition to subsequent states in the sequence, is repeated until the final state of the sequence is reached (or the session is actively or passively discontinued by the user or the microcontroller due to, for example, an extended period of inactivity). Upon reaching the final state, at step 612, the handheld devotional device 102 may execute one or more post prayer session actions, such as generating a completion signal (e.g., to send to the application or to energize an indicator such as by illuminating a light-emitting element on the device) to indicate completion of the current prayer sequence, storing session data for the current prayer sequence, and/or resetting to the initial state to allow a new prayer sequence to be initiated. It should be recognized that the determination of the current state in the sequence of states may be determined by the computing device 104 rather than the microcontroller of the handheld devotional device 102. The values associated with the individual touch sensitive elements 114 may be communicated by the communication module 118 of the devotional device 102 to the computing device 104, and information based upon the determination of the current state by the device 104 may be transmitted to the device 102.

During the devotional session, operation of the system 100 may include the microcontroller 116 receiving input such as binary signals from each of, or a selected group of, the touch sensitive elements 114 of the array of elements. The microcontroller may use the inputs to determine valid sensor activations and trigger state transitions, and outputting updated state information, completion signals, and session data reflecting the progress of the prayer sequence of the devotional session, such as to the computing device 104. In some implementations, data regarding the user's progress during the devotional session may be transmitted from the devotional device 102 to the computing device 104 on a periodic (or even continuous) basis, prior to completion of the prayer sequence, to enable resumption of the prayer sequence in a subsequent devotional session should the session end prior to completion of the prayer sequence.

In some implementations of the system 100, the handheld devotional device 102 may be capable of operating without an active communication connection to the computing device 104. In an illustrative uncoupled or standalone operational mode, the handheld devotional device 102 may utilize a predetermined prayer sequence, such as a traditional rosary prayer sequence, stored on the device 102. In the uncoupled operational mode, a prayer sequence may be initiated through a specific activation signature received from the user. In some implementations, in order to initiate a prayer sequence, the microcontroller 116 of the device may monitor the touch sensitive elements 114 of the device for the occurrence of the specific activation signature received via user contact with the elements 114. For example, the specific activation signature may comprise a first one of the elements 114 being activated for a minimum time interval, and after a predefined delay time interval greater than a threshold time interval, a second one of the elements 114 being activated for a minimum time interval. The detection of the specific activation signature by the microcontroller 116 may indicate to the handheld devotional device 102 that the user intends to progress through a prayer sequence without guidance from the computing device 104. During the uncoupled operational mode, the current state and the prayer sequence may be maintained locally on the device 102 in memory. If the device 102 is powered off before completing the prayer sequence, the state at the time that the powering off is initiated is stored in persistent memory in order to allow resumption of the prayer sequence at a later time. In some embodiments, an indicator (such as an LED) may visually communicate to the user the current status of the prayer sequence, such as, for example, whether the device is already executing an active prayer sequence and where in the sequence the user should start, which may be indicated by the illuminated color of the indicator. Upon initiation or resumption of the sequence, the user may indicate to the device 102, and the microcontroller 116 may detect, whether the user is intending to start at the beginning of the prayer sequence or resume in the middle of the sequence, using an initialization signature of touches or contacts with the touch sensitive elements 114. The distinction between the sequence of touches initiating the point at which the sequence for the session is to begin may be based upon which set of touch sensitive elements 114 are contacted by the user in the initialization signature.

The system 100 offers a significant improvement over conventional devotional aids by preserving the tactile essence of prayer while integrating modern interactive technology. By incorporating the touch-sensitive elements 114 into the handheld devotional device 102 that mimics the structure of the traditional rosary, the system 100 allows the users to engage in prayer in a manner that is both familiar and physically immersive. This tactile interaction not only sustains the meditative quality of the practice but also strengthens the user's spiritual connection by allowing the natural pace and rhythm of prayer to be maintained without the distraction of screens or mobile applications.

Another key advantage of the system 100 lies in its ability to monitor and track user interactions in real time. The microcontroller 116 of the handheld devotional device 102 captures each touch event with precision, thereby enabling the system 100 to gather detailed data on user engagement. This data is transmitted to the computing device 104 and processed through the cloud-based application 106 that provides personalized content and spiritual reflections. The adaptive nature of the system 100 ensures that the users receive context-aware support and tailored insights, thereby enhancing the relevance and depth of their devotional experience.

The system 100 further supports long-term spiritual development through its comprehensive tracking and analytics features. By logging prayer frequency, session duration, and progression through individual prayer elements, the system 100 generates engagement metrics that support the users to reflect on their devotional patterns. These metrics are translated into meaningful insights and recommendations, thereby allowing the users to identify strengths, improve consistency, and set personal faith goals. Such feedback mechanisms encourage continuous growth and foster a more intentional and informed devotional practice.

The system 100 also offers a high degree of personalization, which makes it suitable for a diverse range of the users from novices learning the structure of prayer to experienced individuals seeking deeper meditative engagement. Through the companion application, the users can customize language, prayer themes, and devotional structures according to their personal preferences and spiritual needs. This adaptability ensures that the system 100 can accommodate various cultural, linguistic, and doctrinal preferences, thereby promoting inclusivity and accessibility across different user demographics.

Designed with user convenience in mind, the handheld devotional device 102 is compact, lightweight, and easy to use. The durable construction and integrated power source 120 make the handheld devotional device 102 suitable for daily use and transport, thereby enabling the users to practice devotion anytime and anywhere without reliance on bulky or intrusive devices. The minimal learning curve and intuitive operation further enhance user adoption, especially among those who may be less familiar with digital technologies but are deeply committed to traditional forms of prayer.

Unlike conventional mobile applications that require users to look at or interact with a screen, the system 100 facilitates an uninterrupted, screen-free prayer experience. By focusing interaction on the touch-sensitive elements 114 within the beads 112 of the handheld devotional device 102, the system 100 minimizes visual distractions and cognitive interruptions, thereby preserving the contemplative nature of the ritual. This advantage is particularly beneficial for individuals seeking a more focused and immersive devotional experience.

Another aspect of the disclosure is the ability of a user of the system 100 to generate a prayer card 140 or multiple prayer cards which may be utilized by the user as well as other users of the system. The prayer card 140 may be generally intended to guide or inspire meditation or prayer. The prayer cards may be user-generated or system-generated, which may allow flexibility in content creation and personalization. In implementations of the system, a prayer card 140 may comprise a modular data object representing a unit of contemplative content. The data object representing the prayer card 140 may include text, images, audio references, and metadata. Metadata associated with each card may include usage statistics (e.g., number of prayers completed using the card, unique user identifiers, timestamps), thematic categorization, or semantic tags to support sequence selection and automated personalization.

Prayer cards may be categorized in various ways, such as the purpose or function of the particular prayer or prayers represented by the card. For example, types of prayer cards may include:
1. Opening Prayers Card for the introductory prayers of a prayer sequence.
2. Meditation Card which may be focused on a specific virtue, reflection, or scripture passage for a prayer sequence.
3. Closing Prayer Card for the prayers concluding a prayer sequence.
4. User-Created Reflection Card having personalized content created by a user, such as a prayer intention, meditation, or an image reflecting personal devotion.

The prayer cards may be utilized in prayer sequences for a devotional session. A prayer sequence may be an ordered set of prayer cards, representing a structured series of prayers, meditations, or reflections. Illustratively, traditional Catholic examples include the Rosary or Divine Mercy Chaplet, where each element corresponds to a physical bead or step in the sequence. In the handheld devotional device 102, the touch sensitive element 114 associated with each of the beads 112 correspond to states in the sequence. Activation of a touch sensitive element 114 by contact with the associated bead 112 triggers a state transition, signaling the microcontroller 116 that the user is progressing through the prayer sequence.

In implementations, when the handheld devotional device 102 is utilized with the application 106, each state of the prayer sequence may correspond to a specific prayer card 140. The prayer card may be displayed on the user interface of the handheld devotional device to match the meditative theme of that step of the sequence, and as the sequence progresses, the currently displayed prayer card may be removed from the display and the next card in the sequence may be presented automatically. As an illustrative example, a Rosary prayer sequence may comprise opening prayers (1-3 cards), five decades of 11 elements each (e.g., meditation cards reflecting the mystery of the decade), and closing prayers (1 card). It should be recognized that the system of this disclosure may employ a generalized framework that supports custom sequences which are assembled either by the user or the system. In general, the sequences may differ in terms of the number of elements in the sequence, the order of prayers or meditations in the sequence, and the thematic focus or content type of the sequence.

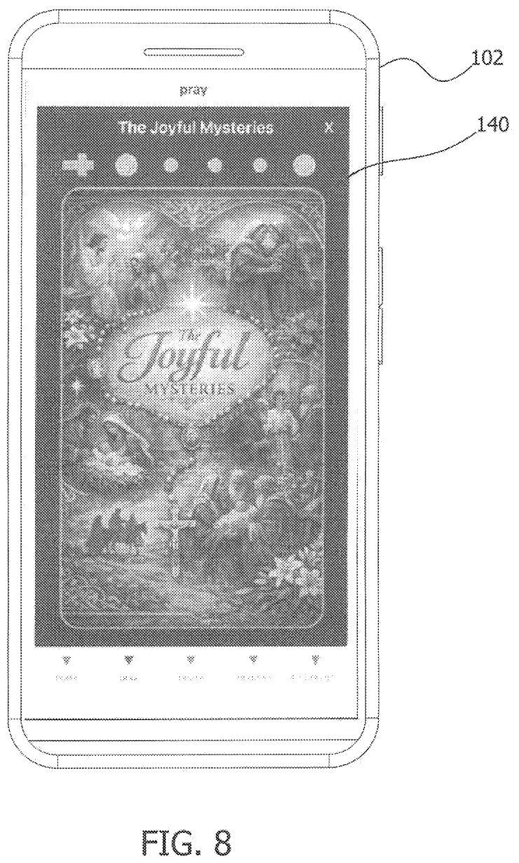

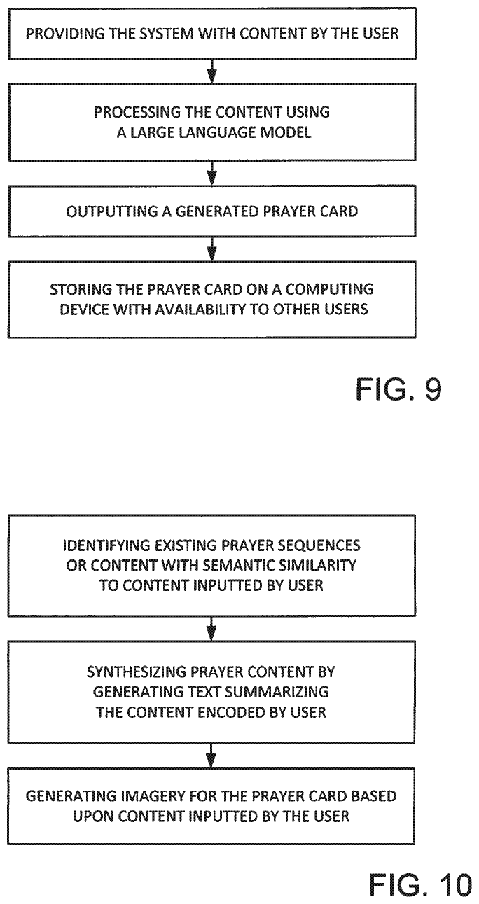

FIG. 9 shows an illustrative method for generating devotional or contemplative content, such as a prayer card, by the system for use in a prayer sequence. The method may include providing the system with content by the user. The provided content may comprise reflective material including contemplative text that connects spiritual, philosophical, or scriptural concepts, such as a reflective text linking theological ideas of light with scientific concepts from physics. The provided content may also comprise intentional material including personal prayer intentions or requests for guidance, such as a prayer for a loved one's health or well-being. The method may further include processing the content from the user by the system. FIG. 10 shows an illustrative method for processing the content by the system, such as by using a large language model (LLM) embedding in order to represent the content in a semantic vector space. Processing of the content by the system may further comprise applying retrieval-augmented generation (RAG) techniques to identify existing prayer sequences or content having semantic similarity to the content input by the user. The processing of the content of the user by the system may further comprise synthesizing prayer content by generating text that summarizes the user input in a prayerful, structured format suitable for a prayer card 140. Illustratively, multiple LLM prompts may be utilized by the system to help ensure the output adheres to length, tone, and thematic appropriateness for meditative use. Further, the processing of the content may include generating imagery for the prayer card, such as imagery based on the input text and its semantic relationship to the matched prayer sequence to help ensure that the prayer card provides both visual and textual guidance for contemplation. Returning to FIG. 9, the method may also include outputting the generated prayer card which may comprise formatted textual content reflecting the user input and the associated prayer sequence and may also comprise corresponding imagery which is aligned with the theme of the prayer or meditation. The completed prayer card may be stored in the computing device 104 associated with the user and may be made available for use in prayer sequences on the handheld devotional device 102 and/or the application 106.

In addition to the metrics identified above for which the system 100 may collect or track data, implementations of the system may also track data related to content creation by one or more users of the system, including, for example:
1. The number of prayer cards created by the users that are currently in use or not deleted.
2. The total number of prayer cards created by the user, which may include inactive or archived cards.
3. The distribution of user-created cards among different content types or thematic categories.

In further implementations, the system 100 may track data related to engagement by others with content created by a user, including, for example:
1. A number of times other users have prayed using the user's cards.
2. An average number of prayers undertaken by others per prayer card created by the user.
3. Identification of prayer sequence types where the user's cards appear.
4. The number of unique users that have interacted with the user's cards.
5. The time period since the user's cards were last used or interacted with by another user.
6. The prayer cards most frequently used on the system or within a defined group of users on the system.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of monitoring and enhancing contemplative practices using an interactive electronic device, said method comprising:
providing an interactive electronic device comprising a plurality of touch-sensitive sensors; a communication module within said interactive electronic device, a data store within said interactive electronic device, said data store containing a plurality of machine-readable instructions; and a microcontroller in communication with said plurality of touch-sensitive sensors, said communication module, and said data store;
initiating a contemplative session by a user interacting with said interactive electronic device;
detecting, by said microcontroller, individual touch interactions on each of said plurality of touch-sensitive sensors during said contemplative session;
assigning, through said microcontroller, an identifier to each of said individual touch interactions to record a plurality of metadata tied to each said individual touch interaction;
receiving, by a computing device, said individual touch interactions and said plurality of metadata;
analyzing, by said computing device, said individual touch interactions and said plurality of metadata to determine a user's prayer activity; and
logging a plurality of user engagement metrics based on a user's prayer activity.

2. The method of claim 1 wherein each of said plurality of touch-sensitive sensors includes a capacitive touch input, said capacitive touch input in electronic communication with said microcontroller, the method further including the step of registering, through said microcontroller, a plurality of raw capacitance values based on a deviation from a baseline capacitance during said individual touch interactions.

3. The method of claim 1 further including the step of registering a sequence of states within said contemplative session, each state corresponding to the active electrical state of one of said plurality of touch-sensitive sensors.

4. The method of claim 3 further including the step of transitioning through said sequence of states and registering different active touch-sensitive sensors within each state of said contemplative session.

5. The method of claim 4 wherein said interactive electronic device further includes a light emitting element coupled to said housing, said light emitting element being electronically coupled to said microcontroller, said method further including the step of activating said light emitting element in response to said plurality of individual touch interactions.

6. The method of claim 1 wherein said method further includes the steps of:
transmitting, through said communication module, said individual touch interactions and said plurality of metadata to a computing device in communication with said communication module;
presenting, on the computing device, personalized prayer content based on said user's prayer activity; and
presenting, on said computing device, said plurality of user engagement metrics and said user prayer activity to the user.

7. The method of claim 1 wherein said touch-sensitive sensors are arranged in a configuration corresponding to a traditional Catholic rosary.

8. The method of claim 1 wherein said plurality of user engagement metrics include prayer habits.

9. The method of claim 8 wherein said method further includes the step of providing spiritual growth recommendations based on said prayer habits.

10. A system of monitoring and enhancing contemplative practices comprising:
an interactive electronic device including:
a housing;
a microcontroller associated with said housing, said microcontroller having a plurality of inputs;
a data store associated with said housing, said data store being in communication with said microcontroller, said data store containing a plurality of machine-readable instructions;
a plurality of touch-sensitive sensors supported on a connecting framework, said touch sensitive sensors being arrayed on said connecting framework at spaced locations along the connecting framework, each of said touch sensitive sensors being configured to generate an input signal when the user contacts the said sensor; and
wherein, for each said touch sensitive sensor, a conductor extends from the said sensor to a said input of the microcontroller to communicate a said input signal from the said sensor to the input of the microcontroller to detect a touch interaction with said sensor.

11. The system of claim 10 wherein said plurality of machine-readable instructions contained on said data store are configured to cause said microcontroller to:
initiate a contemplative session by a user interacting with one of said plurality of touch-sensitive sensors;
detect, by said microcontroller, individual touch interactions with each of said plurality of touch-sensitive sensors during said contemplative session;
assign, through said microcontroller, an identifier to each of said individual touch interactions to record a plurality of metadata associated with each said individual touch interaction;
receive, by a computing device, said individual touch interactions and said plurality of metadata;
analyze, by said computing device, said individual touch interactions and said plurality of metadata to determine a user's prayer activity; and
log a plurality of user engagement metrics based on a user's prayer activity.

12. The system of claim 10 wherein said interactive electronic device additionally includes a communication module associated with said housing, said communication module being in communication with the microcontroller.

13. The system of claim 10 wherein said plurality of machine-readable instructions contained on said data store are configured to cause said microcontroller to define active and non-active inputs of the plurality of inputs for the microcontroller based upon a prayer sequence for touches of the touch sensitive sensors.

14. The system of claim 10 wherein said plurality of machine-readable instructions are further configured to cause said microcontroller to register a sequence of states within said contemplative session, each state corresponding to the active electrical state of one of said plurality of touch-sensitive sensors.

15. The system of claim 14 wherein said plurality of machine-readable instructions are further configured to cause said microcontroller to transition through said sequence of states and register different active touch-sensitive sensors within each state of said contemplative session.

16. The system of claim 15 wherein said plurality of machine-readable instructions are further configured to cause said microcontroller to define non-active inputs associated with nonactive touch sensitive sensors based upon a prayer sequence for touches of the touch sensitive sensors.

17. The system of claim 16 wherein said plurality of machine-readable instructions are further configured to cause said microcontroller to monitor a duration of a said input signal of a said touch sensitive sensor for determining if the duration meets a threshold time interval indicating an intentional touch of said touch sensitive sensor.

18. The system of claim 17 wherein said plurality of machine-readable instructions are further configured to cause said microcontroller to initiate a prayer sequence upon receipt of an activation signature of input signals from said touch sensitive sensors characterized by a sequence of a minimum time interval of a first touch sensitive sensor activation, a predefined delay time interval, and a minimum time interval of a second touch sensitive sensor activation.

19. The system of claim 16 wherein said plurality of machine-readable instructions are further configured to cause said microcontroller to store, in said data store, information regarding a current state of progression of the prayer sequence during a prior session such that the information is available to the microcontroller after termination and resumption of power to the microcontroller in order to resume the prayer sequence at a later time.

20. The system of claim 12 wherein said plurality of machine readable instructions further includes instructions configured to cause the microcontroller to:
transmit, through said communication module, said individual touch interactions and said plurality of metadata to a computing device in communication with said communication module;
present, on the computing device, personalized prayer content based on said user's prayer activity; and
present, through the computing device, said plurality of user engagement metrics and said user prayer activity to the user.
